(19) United States
(12) Patent Application Publication
(10) Pub. No.: US 2016/0187195 A1
(43) Pub. Date: Jun. 30, 2016

(54) ILLUMINANCE SENSOR MODULE

(71) Applicant: Samsung Electro-Mechanics Co., Ltd., Suwon-si (KR)

(72) Inventors: Phil Ho JUNG, Suwon-si (KR); Ho Sik YOU, Suwon-si (KR)

(73) Assignee: SAMSUNG ELECTRO-MECHANICS CO., LTD., Suwon-si (KR)

(21) Appl. No.: 14/936,398

(22) Filed: Nov. 9, 2015

(30) Foreign Application Priority Data
Dec. 29, 2014 (KR) 10-2014-0192421

(51) Int. Cl. G01J 1/42; G01J 1/04

(52) U.S. Cl. CPC G01J 1/42; G01J 1/0474

(57) ABSTRACT

An illuminance sensor module includes: a lens having refractive power; a diffuser configured to scatter light incident through the lens; an illuminance sensor configured to receive the light passing through the diffuser; and a field stop disposed at a point at which the light is focused by the lens, wherein the lens, the diffuser, and the illuminance sensor are sequentially disposed in a direction from a light source.

### CROSS-REFERENCE TO RELATED APPLICATION(S)

This application claims the benefit of Korean Patent Application No. 10-2014-0192421 filed on Dec. 29, 2014 in the Korean Intellectual Property Office, the entire disclosure of which is incorporated herein by reference for all purposes.

### BACKGROUND

1. Field

The following description relates to an illuminance sensor module.

2. Description of Related Art

Recently, portable terminals such as mobile communications devices have come into widespread use due to convenience, ease of portability, and the like, and have provided various functions such as text message transmission and reception functions, an image capturing function, a music play-back function, a digital broadcasting service function, an E-mail function, an instant messenger function, and the like.

Particularly, recently, a portable terminal including an illuminance sensor for adjusting brightness of a display unit of the portable terminal depending on external brightness has become more widely used.

That is, when a surrounding environment is bright (when external illuminance is high), brightness of the display unit of the portable terminal may be increased in order to improve legibility, and, when the surrounding environment is dark (when the external illuminance is low), the brightness of the display unit of the portable terminal may be set to be relatively low.

As described above, an illuminance sensor is used to measure illuminance of the surrounding environment. However, in a case in which light is not uniformly incident on the illuminance sensor, it may be difficult to accurately measure the level of illuminance.

In addition, in accordance with a recent trend for the miniaturization of portable terminals, sizes of illuminance sensors need to be decreased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an illuminance sensor module includes: a lens having refractive power; a diffuser configured to scatter light incident through the lens; an illuminance sensor configured to receive the light passing through the diffuser; and a field stop disposed at a point at which the light is focused by the lens, wherein the lens, the diffuser, and the illuminance sensor are sequentially disposed in a direction from a light source.

The lens may have positive refractive power.

The illuminance sensor module may further include an aperture stop configured to adjust an amount of light is disposed in front of the lens.

At least one surface of the lens may be aspherical.

The lens may be constructed of plastic.

The expression FOV>30 may be satisfied, with FOV being a field of view of the lens.

The expression 0.5 mm<X<2.0 mm may satisfied, with X being a distance between the diffuser and the illuminance sensor.

The expression FSD>0.5895 mm may be satisfied, with FSD being a diameter of the field stop.

The field stop may be closely adhered to the diffuser.

The field stop may be spaced apart from the diffuser.

When the light passing through the diffuser is collected in the illuminance sensor, the light may have uniform intensity distribution.

According to another general aspect, an illuminance sensor module includes: a lens having refractive power; a diffuser configured to scatter light incident through the lens; an illuminance sensor configured to receive the light passing through the diffuser; an aperture stop disposed in front of the lens and configured to adjust an amount of light disposed in front of the lens; and a field stop disposed at a point at which the light is focused by the lens, wherein the lens, the diffuser, and the illuminance sensor are sequentially disposed in a direction from a light source, and wherein ASD/EFL≧0.45 is satisfied, with ASD being a diameter of the aperture stop and EFL being an overall focal length of the lens.

First and second surfaces of the lens may be aspherical, and the lens may be constructed of plastic.

The expression FOV>30 may be satisfied, with FOV being a field of view of the lens.

The expression 0.5 mm<X<2.0 mm may be satisfied, with X being a distance between the diffuser and the illuminance sensor.

The expression FSD>0.5895 mm may be satisfied, with FSD being a diameter of the field stop.

A field of view of the lens may be about 32 degrees and the ASD may be about 0.6308 mm.

A distance from a light source-side surface of the lens to the point at which the light is focused by the lens is ay be 1.4 mm.

Other features and aspects will be apparent from the following detailed description, the drawings, and the claims.

### BRIEF DESCRIPTION OF THE DRAWINGS

FIG. 1 is a view of an illuminance sensor module according to an example.

FIG. 2 is a view illustrating a change in a position of a field stop in the illuminance sensor module.

FIG. 3 is a table illustrating example characteristics of a lens included in the illuminance sensor module.

FIG. 4 is a table illustrating example characteristics of the illuminance sensor module.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the following description, a first surface of a lens refers to a surface that is relatively closer to a light source (or a light source-side surface) and a second surface thereof refers to a surface that is relatively closer to an illuminance sensor (or a sensor-side surface).

In addition, EFL, X, SD, TTL, a diameter of an aperture stop, a diameter of a field stop, a thickness of a diffuser, a thickness of an illuminance sensor, and a thickness of a printed circuit board to be described below are expressed in millimeters (mm), and field of view (FOV) is expressed in degrees.

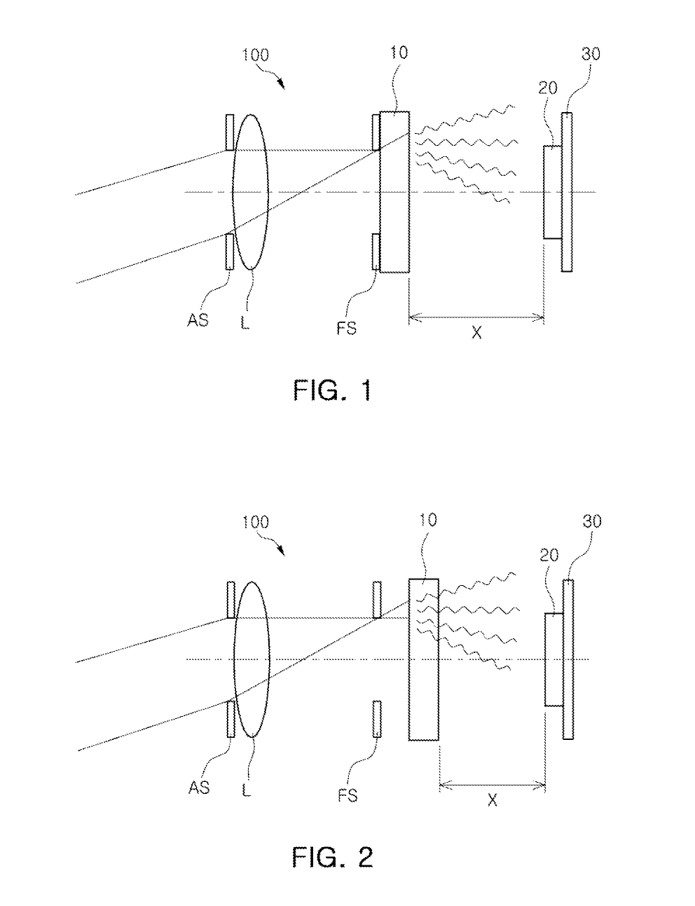

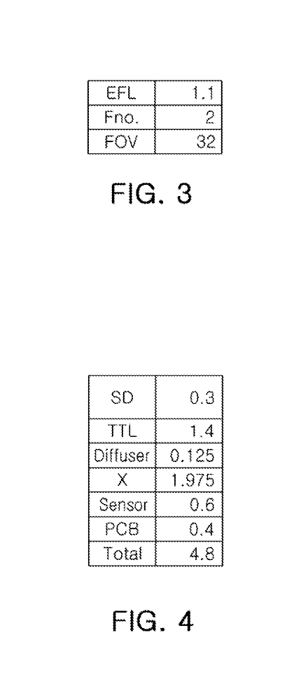

FIG. 1 is a view of an illuminance sensor module 100 according to an example, and FIG. 2 is a view illustrating a change in a position of a field stop FS in the illuminance sensor module 100. In addition, FIG. 3 is a table illustrating example characteristics of a lens L included in the illuminance sensor module 100, and FIG. 4 is a table illustrating example characteristics of the illuminance sensor module 100.

Referring to FIGS. 1 and 2, the illuminance sensor module 100 includes an aperture stop AS, the lens L, the field stop FS, a diffuser 10, an illuminance sensor 20, and a printed circuit board 30.

In addition, although not illustrated, a housing may be provided, and the aperture stop AS, the lens L, the field stop FS, the diffuser 10, the illuminance sensor 20, and the printed circuit board 30 may be fixedly disposed in the housing, sequentially from a light source side thereof.

Both surfaces of the lens L may be convex. For example, the first (light source-side) and second (sensor-side) surfaces of the lens L may be convex. Therefore, the lens L may have positive refractive power. However, a shape of the lens L is not limited to having convex first and second sides, but may be a shape in which a thickness of a central portion of the lens L is thicker than that of a surrounding portion of the lens L so that the lens L has the positive refractive power.

At least one of the first surface and the second surface of the lens L may be aspherical in order to significantly decrease an influence of spherical aberrations.

In addition, the lens L may be formed of plastic, such that manufacturing costs of the lens L may be decreased and productivity of the lens L may be improved.

The aperture stop AS is disposed in front of the lens L. The aperture stop AS adjusts an amount of light incident to the illuminance sensor module 100.

Referring to FIG. 4, in an example, a distance SD from the aperture stop AS to the light source-side surface of the lens may be 0.3 mm.

The Fno. of the illuminance sensor module 100 may be, for example, equal to or less than about 2.2. Fno. refers to an inverse number of an aperture ratio, and the aperture ratio refers to a ‘ratio between an effective aperture and a focal length of the lens’. As the Fno. is decreased, the amount of light incident to the illuminance sensor module 100 is increased.

Since the aperture stop AS is disposed in front of the lens L in the illuminance sensor module 100, the effective aperture of the lens L may be determined by a diameter of the aperture stop AS. The illuminance sensor module 100 may satisfy Conditional Expression 1.

ASD/EFL≧0.45 [Conditional Expression 1]

In Conditional Expression 1, ASD is a diameter of the aperture stop AS, and EFL is an overall focal length of the lens L. That is, in the illuminance sensor module 100, the aperture ratio may be represented by ASD/EFL, and since the aperture ratio (ASD/EFL) is equal to or greater than 0.45, Fno. (which is an inverse number of the aperture ratio (ASD/EFL)) may be equal to or greater than 2.2.

The illuminance sensor 20 detects light and outputs electrical signals (for example, voltage signals) in response to a light input. That is, the illuminance sensor 20 measures illuminance of a surrounding environment through light incident to the illuminance sensor module 100, and is mounted on the printed circuit board 30 to configure a sensor package.

Referring to FIG. 4, according to an example, a thickness of the illuminance sensor 20 may be about 0.6 mm, and a thickness of the printed circuit board 30 may be about 0.4 mm. Therefore, an overall thickness of the sensor package may be about 1.0 mm.

The illuminance sensor 20 may also be used for proximity sensing. For example, the illuminance sensor module 100 may separately include a light emitting part (not illustrated) for the proximity sensing.

Here, an output (for example, a voltage) of the illuminance sensor 20 will be described. In a case in which external light (natural light) is incident to the illuminance sensor 20, electrical signals may be output continuously, depending on intensity of the light, and in a case in which light emitted from the light emitting part is incident to the illuminance sensor, electrical signals may be output in a manner in which they are turned on/off at a predetermined period. That is, in a case in which a user or any object approaches the illuminance sensor module 100, the light of the light emitting part is reflected by the user or any object approaching the illuminance sensor module 100 to thereby be incident to the illuminance sensor module 100. In this case, the external light (the natural light) is blocked by the user or the object, such that an amount of external light incident to the illuminance sensor module 100 becomes relatively small.

Therefore, in the case in which the user or any object approaches the illuminance sensor module 100, the light of the light emitting part may be stronger than the external light (the natural light). Therefore, the illuminance sensor module 100 may be used for proximity sensing by confirming an output form of the illuminance sensor module 100.

Since the lens L has refractive power, in a case in which light passing through the lens L is directly collected in the illuminance sensor 20, it may be difficult for the light to be uniformly collected in the illuminance sensor 20. Therefore, the illuminance sensor module 100 includes the diffuser 10. The diffuser 10 is disposed between the lens L and the illuminance sensor 20 and scatters the light incident through the lens L before the light is collected in the illuminance sensor 20. Therefore, the light incident to the illuminance sensor 20 may have uniform intensity distribution by the diffuser 10.

However, in a case in which a distance between the diffuser 10 and the illuminance sensor 20 is excessively short, the distribution of intensity of the light incident to the illuminance sensor 20 may not be uniform, and in a case in which a distance between the diffuser 10 and the illuminance sensor 20 is excessively long, energy intensity of the light incident to the illuminance sensor 20 may be decreased. Therefore, a distance between the diffuser 10 and the illuminance sensor 20 needs to be set. Accordingly, illuminance sensor module 100 may satisfy Conditional Expression 2.

0.5<X<2.0 [Conditional Expression 2]

In Conditional Expression 2, X is a distance between the diffuser 10 and the illuminance sensor 20.

In a case in which the distance X between the diffuser 10 and the illuminance sensor 20 is outside of the range of Conditional Expression 2, it may be difficult for the light incident to the illuminance sensor 20 to have uniform intensity distribution or, even though the light incident to the illuminance sensor 20 has uniform intensity distribution, energy intensity of the light incident to the illuminance sensor 20 may be decreased, such that light receiving efficiency of the illuminance sensor 20 may not be good.

In addition, in a case in which the distance X between the diffuser 10 and the illuminance sensor 20 is 2.0 mm or more, a height (that is, a distance from the aperture stop AS to the printed circuit board 30) of the illuminance sensor module 100 is generally increased.

However, in the illuminance sensor module 100, the distance X between the diffuser 10 and the illuminance sensor 20 may be adjusted to satisfy Conditional Expression 2, thereby allowing the light incident to the illuminance sensor 20 to have the uniform intensity distribution while appropriately maintaining the intensity of the light incident to the illuminance sensor 20. In addition, the distance X between the diffuser 10 and the illuminance sensor 20 may be adjusted to satisfy Conditional Expression 2, whereby the illuminance sensor module 100 may be formed to be slim.

The field stop FS is disposed at a point at which light is focused by the lens L. Therefore, only light in a predetermined field of view is collected in the illuminance sensor 20 by the field stop FS. The illuminance sensor module 100 may satisfy Conditional Expression 3.

FOV>30 [Conditional Expression 3]

In Conditional Expression 3, FOV is a field of view of the illuminance sensor module 100, and the field of view (FOV) is expressed in degrees.

In addition, the illuminance sensor module 100 may satisfy Conditional Expression 4.

FSD>0.5895 [Conditional Expression 4]

In Conditional Expression 4, FSD is a diameter of the field stop FS.

Referring to FIG. 3, in an example, a field of view (FOV) of the lens L may be 32 degrees. In addition, the diameter (FSD) of the field stop FS, allowing the field of view (FOV) of the lens L to be 32 degrees, may be 0.6308 mm. Alternatively, the FSD may be about 32 degrees and the FOV may be about 0.6308 mm. However, the field of view (FOV) of the lens L and the diameter of the field stop FS are not limited to these values, but may be determined in the ranges of Conditional Expressions 3 and 4.

Referring to FIG. 4, in an example, a distance (TTL) from the light source-side surface of the lens L to the point at which the light is focused by the lens L may be 1.4 mm. Alternatively, the TTL may be about 1.4 mm. Therefore, the field stop FS may be disposed in a position spaced apart from the light source-side surface of the lens L by a distance of 1.4 mm. Since light having a field of view exceeding a predetermined field of view is blocked by the field stop FS, the diameter of the field stop FS may be 0.6308 mm, such that the field of view (FOV) of the lens L may be set to be 32 degrees.

Therefore, in the illuminance sensor module 100, since only light in the field of view of 32 degrees may be collected in the illuminance sensor 20, the generation of a sensing error due to unnecessary ambient light may be prevented. In addition, only the light in the field of view of 32 degrees may pass through the diffuser 10 by the field stop FS, and the light collected in the illuminance sensor 20 may have uniform intensity distribution by the diffuser 10.

Since the field stop FS is disposed at the point at which the light is focused by the lens L, the field stop FS may be closely adhered to the diffuser 10 or may be spaced apart from the diffuser 10 depending on a focal length of the lens L.

Example characteristics of the illuminance sensor module 100 in a case in which the field stop FS is closely adhered to the diffuser 10 are illustrated in FIG. 4. The distance (SD) from the aperture stop AS to the light source-side surface of the lens L may be 0.3 mm, and the distance (TTL) from the light source-side surface of the lens L to the point at which the light is focused by the lens L may be 1.4 mm. In addition, a thickness of the diffuser 10 may be 0.125 mm, and the distance X between the diffuser 10 and the illuminance sensor 20 may be 1.975 mm. In addition, the thickness of the illuminance sensor 20 may be 0.6 mm, and the thickness of the printed circuit board 30 on which the illuminance sensor 20 is mounted may be 0.4 mm.

Therefore, as shown in FIG. 4, in the illuminance sensor module 100, a total length from the aperture stop AS to the printed circuit board 30 may be 4.8 mm. That is, the light having a predetermined field of view may be uniformly collected in the illuminance sensor 20, and the illuminance sensor module 100 may be slim.

As set forth above, the light arriving at the illuminance sensor 20 may have uniform intensity distribution. In addition, an overall height of the illuminance sensor module 100 may be decreased.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An illuminance sensor module comprising:
a lens having refractive power;
a diffuser configured to scatter light incident through the lens;
an illuminance sensor configured to receive the light passing through the diffuser; and
a field stop disposed at a point at which the light is focused by the lens,
wherein the lens, the diffuser, and the illuminance sensor are sequentially disposed in a direction from a light source.

2. The illuminance sensor module of claim 1, wherein the lens has positive refractive power.

3. The illuminance sensor module of claim 1, further comprising an aperture stop configured to adjust an amount of light is disposed in front of the lens.

4. The illuminance sensor module of claim 1, wherein at least one surface of the lens is aspherical.

5. The illuminance sensor module of claim 1, wherein the lens is constructed of plastic.

6. The illuminance sensor module of claim 1, wherein the expression FOV>30 is satisfied, with FOV being a field of view of the lens.

7. The illuminance sensor module of claim 1, wherein the expression 0.5 mm<X<2.0 mm is satisfied, with X being a distance between the diffuser and the illuminance sensor.

8. The illuminance sensor module of claim 1, wherein the expression FSD>0.5895 mm is satisfied, with FSD being a diameter of the field stop.

9. The illuminance sensor module of claim 1, wherein the field stop is closely adhered to the diffuser.

10. The illuminance sensor module of claim 1, wherein the field stop is spaced apart from the diffuser.

11. The illuminance sensor module of claim 1, wherein when the light passing through the diffuser is collected in the illuminance sensor, the light has uniform intensity distribution.

12. An illuminance sensor module comprising:
a lens having refractive power;
a diffuser configured to scatter light incident through the lens;
an illuminance sensor configured to receive the light passing through the diffuser;
an aperture stop disposed in front of the lens and configured to adjust an amount of light disposed in front of the lens; and
a field stop disposed at a point at which the light is focused by the lens,
wherein the lens, the diffuser, and the illuminance sensor are sequentially disposed in a direction from a light source, and
wherein the expression ASD/EFL≧0.45 is satisfied, with ASD being a diameter of the aperture stop and EFL being an overall focal length of the lens.

13. The illuminance sensor module of claim 12, wherein first and second surfaces of the lens are aspherical, and the lens is constructed of plastic.

14. The illuminance sensor module of claim 12, wherein the expression FOV>30 is satisfied, with FOV being a field of view of the lens.

15. The illuminance sensor module of claim 12, wherein the expression 0.5 mm<X<2.0 mm is satisfied, with X being a distance between the diffuser and the illuminance sensor.

16. The illuminance sensor module of claim 12, wherein the expression FSD>0.5895 mm is satisfied, with FSD being a diameter of the field stop.

17. The illuminance sensor module of claim 12, wherein a field of view of the lens is about 32 degrees and the ASD is about 0.6308 mm.

18. The illuminance sensor module of claim 17, wherein a distance from a light source-side surface of the lens to the point at which the light is focused by the lens is about 1.4 mm.
